(19) United States
(12) Patent Application Publication
(10) Pub. No.: US 2022/0010924 A1
(43) Pub. Date: Jan. 13, 2022

(54) Exhaust Device for a Grease Gun

(71) Applicant: Shuoxing Metal Products (Kunshan) CO., LTD., Jiangsu (CN)

(72) Inventor: HENG-CHIA KUO, Jiangsu (CN)

(73) Assignee: Shuoxing Metal Products (Kunshan) CO., LTD.

(21) Appl. No.: 16/927,644

(22) Filed: Jul. 13, 2020

(51) Int. Cl. F16N 3/12

(52) U.S. Cl. CPC F16N 3/12

(57) ABSTRACT

An exhaust device for a grease gun includes: a grease output valve, a normally closed unit, an exhaust valve and an adjusting member. The integral design of the exhaust valve and the adjusting member provided on the grease output valve enables the adjusting member to be adjusted to the exhaust position during the exhaust operation, so that the blocking portion of the adjusting member does not block the exhaust hole from the exhaust passage but allows the exhaust hole to communicate with the exhaust passage. At this time, the air in the grease output passage of the grease output valve can be exhausted through the exhaust passage and the exhaust hole, so that the grease gun can smoothly pump out grease.

### BACKGROUND

### Field of the Invention

The present invention relates to an exhaust device, and more particularly to an exhaust device for a grease gun.

### Related Prior Art

A grease gun is a tool that fills grease into mechanical equipment. The grease gun mainly uses the reciprocating movement of the pump rod to continuously push the grease in the passage of the gun body. When the pump rod moves forward, the grease in the passage is pushed out of the muzzle, and then the muzzle is closed by a check valve. When the pump rod moves backward, the air pressure in the passage will drop, and the pressure inside the grease bucket connected to the grease gun will become relatively higher. The pressure difference will cause the grease in the grease bucket to flow into the passage, and then the grease will be pushed out when the pump rod moves forward again. By repeating the foregoing steps, the grease can be continuously pumped out.

However, in the process of refilling the grease in the grease gun, it is inevitable that the grease contains air. Moreover, different fluids have differences in fluid property, that is, the grease cannot be compressed but the air can. Therefore, during the reciprocating movement of the pump rod in the passage, the grease is gradually pushed out while the air gradually accumulates in the passage. As a result, when the pump rod moves backward, the pressure drop in the passage becomes smaller and smaller, which ultimately lead to the fact that the pressure difference between the passage and the grease bucket becomes too small to push the grease from the grease bucket into the passage, resulting in the idling situation where the pump rod is just pushing the air in the passage and the grease cannot be pushed out.

The present invention has arisen to mitigate and/or obviate the afore-described disadvantages.

### SUMMARY

One objective of the present invention is to provide an exhaust device for a grease gun capable of exhausting the air in the grease in the passage of the grease gun.

To achieve the above objective, an exhaust device for a grease gun in accordance with the present invention comprises: a grease output valve including a grease output passage and an assembling hole communicating with the grease output passage, the grease output passage including a grease inlet, a grease outlet, and a shrinking hole located between the grease inlet and the grease outlet; a normally closed unit arranged at the grease outlet of the grease output valve to provide a pre-pressure to seal the shrinking hole; an exhaust valve assembled to the grease output valve, and including an exhaust passage communicating with the grease output passage, and an exhaust hole communicating with the exhaust passage; and an adjusting member assembled to the exhaust valve, movable between a closed position and an exhaust position, and including an adjusting portion and a blocking portion movably disposed in the exhaust passage to make the exhaust hole communicate or not communicate with the exhaust passage;

when the adjusting member is in the closed position, the blocking portion blocks the exhaust hole from communicating with the exhaust passage, and when the adjusting member is in the exhaust position, the blocking portion allows the exhaust hole to communicate with the exhaust passage.

The invention has the following effects: the integral design of the exhaust valve and the adjusting member provided on the grease output valve enables the adjusting member to be adjusted to the exhaust position during the exhaust operation, so that the blocking portion of the adjusting member does not block the exhaust hole from the exhaust passage but allows the exhaust hole to communicate with the exhaust passage. At this time, the air in the grease output passage of the grease output valve can be exhausted through the exhaust passage and the exhaust hole, so that the grease gun can smoothly pump out grease.

Preferably, the normally closed unit includes a limiting ring, a ball and an elastic element, the limiting ring is disposed at the grease outlet, the ball is configured to seal or not seal the shrinking hole of the grease output valve, and the elastic element is arranged between the limiting ring and the ball to provide a pre-pressure to the ball.

Preferably, the exhaust passage includes an air inlet communicating with the grease output passage, the adjusting member further includes a plug portion connected to the blocking portion, an outer diameter of the plug portion is smaller than an inner diameter of the exhaust passage, and the plug portion is configured to seal or not seal the air inlet. When the adjusting member is in the closed position, the plug portion seals the air inlet, and when the adjusting member is in the exhaust position, the plug portion stops sealing the air inlet.

Preferably, an outer diameter of the plug portion is smaller than an outer diameter of the blocking portion.

Preferably, the adjusting portion of the adjusting member is located outside the exhaust valve.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a cross-sectional view of an assembly of an embodiment of the present invention;

FIG. 2 is a view of an embodiment of the present invention in operation, showing that there is air in the grease output passage of the grease output valve;

FIG. 3 is a view of the embodiment of the present invention in operation, showing that the air in the grease output valve is discharged through the exhaust passage and the exhaust hole;

FIG. 4 is an illustrative view of an embodiment of the present invention, showing that the present invention is assembled to a pneumatic grease gun; and

FIG. 5 is an illustrative view of an embodiment of the present invention, showing that the present invention is assembled to a manual grease gun.

### DETAILED DESCRIPTION

The present invention will be clearer from the following description when viewed together with the accompanying drawings, which show, for purpose of illustrations only, the preferred embodiment in accordance with the present invention.

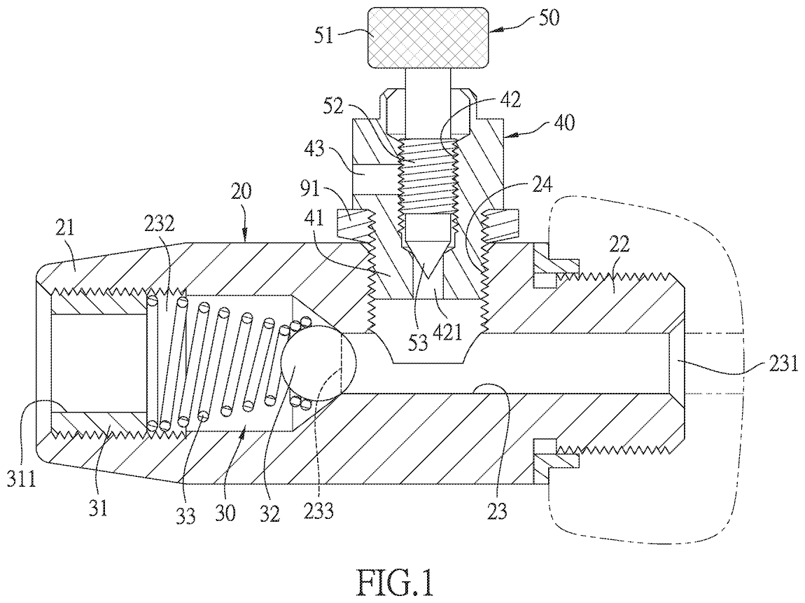

Referring to FIG. 1, an exhaust device for a grease gun in accordance with an embodiment of the invention is suitable for being assembled to a grease gun, and comprises: a grease output valve 20, a normally closed unit 30, an exhaust valve 40 and an adjusting member 50.

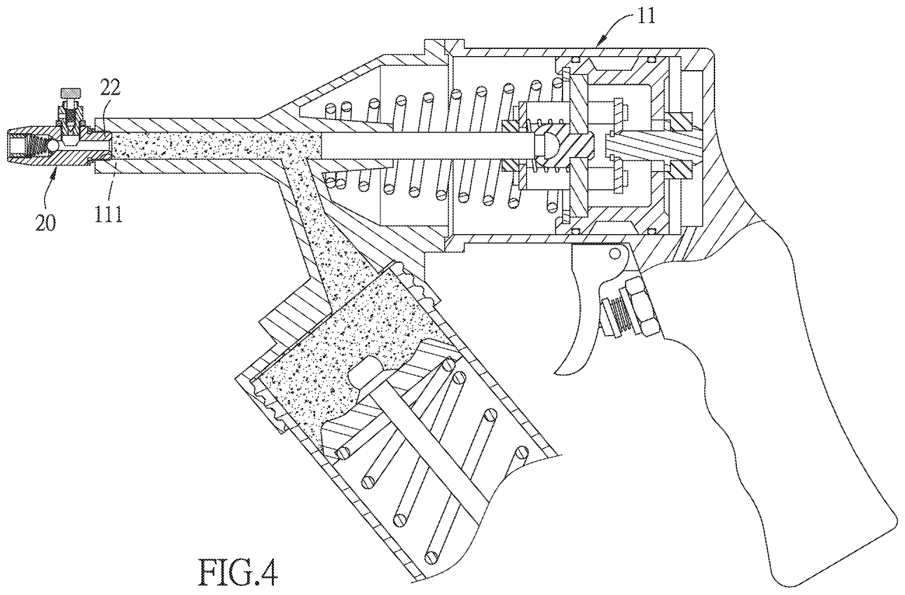

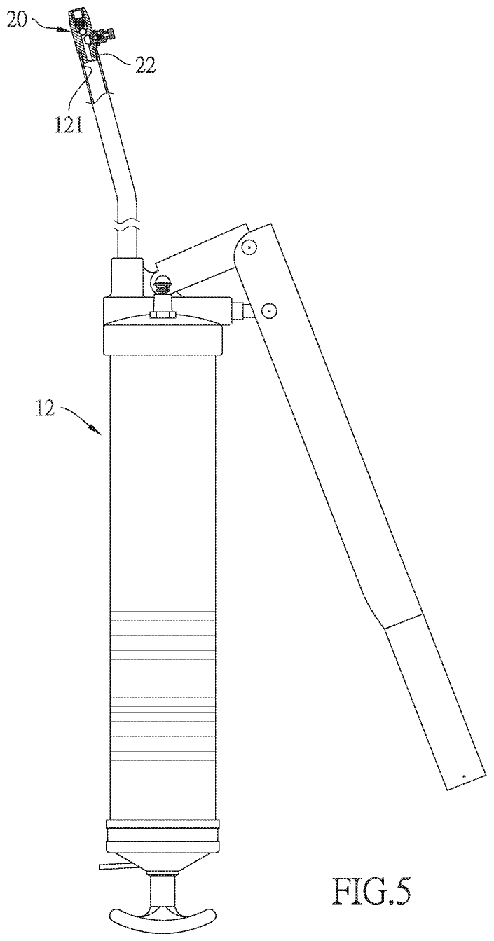

The grease output valve 20 includes a first end 21, a second end 22 opposite to the first end 21 and including a threaded section, a grease output passage 23 extending between the first end 21 and the second end 22, and an assembling hole 24 communicating with the grease output passage 23. The grease output passage 23 includes a grease inlet 231 corresponding to the second end 22, a grease outlet 232 corresponding to the first end 21, a shrinking hole 233 between the grease inlet 231 and the grease outlet 232, and the assembling hole 24 is located between the shrinking hole 233 and the grease inlet 231. As shown in FIG. 4, in this embodiment, the grease output valve 20 is screwed to an outlet end 111 of a pneumatic grease gun 11 via the second end 22. Alternatively, as shown in FIG. 5, the second end 22 of the grease output valve 20 can be screwed to an outlet end 121 of a manual grease gun 12.

The normally closed unit 30 is arranged at the grease outlet 232 of the grease output valve 20 and provides a pre-pressure to seal the shrinking hole 233. In this embodiment, the normally closed unit 30 includes a limiting ring 31, a ball 32 and an elastic element 33. The limiting ring 31 is screwed to the grease outlet 232 and provided with a through hole 311 communicating with the shrinking hole 233, the ball 32 is configured to seal or not seal the shrinking hole 233 of the grease output valve 20, and the elastic element 33 is a compression spring arranged between the limiting ring 31 and the ball 32 to provide a pre-pressure to the ball 32, so that the ball 32 applied with the pre-pressure can seal the shrinking hole 233.

The exhaust valve 40 is assembled to the grease output valve 20, and includes an assembling portion 41 screwed to the assembling hole 24, an exhaust passage 42 communicating with the grease output passage 23, and an exhaust hole 43 communicating with the exhaust passage 42. In this embodiment, the exhaust passage 42 includes an air inlet 421 communicating with the assembling hole 24 and the grease output passage 23, and in order to ensure the airtightness after the exhaust valve 40 and the grease outlet valve 20 are assembled with each other, an airtight ring 91 is provided between the assembling portion 41 of the exhaust valve 40 and the assembling hole 24 of the grease output valve 20.

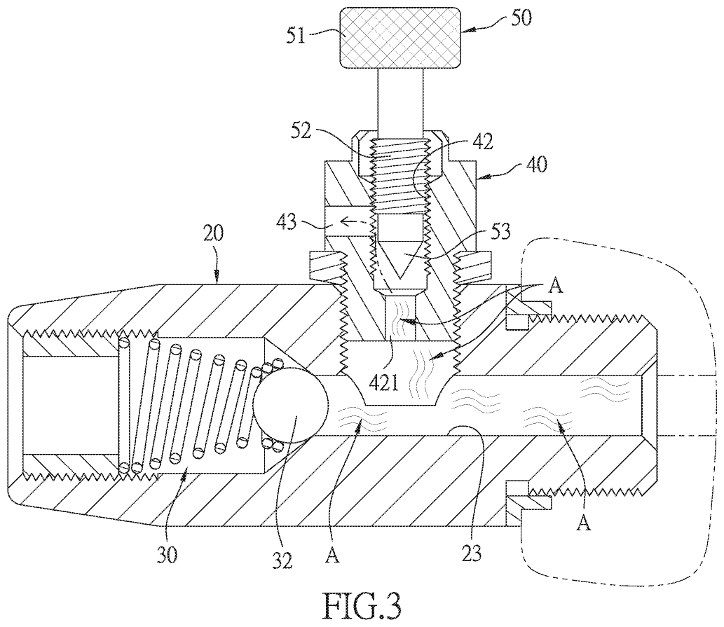

The adjusting member 50 is assembled to the exhaust valve 40, movable between a closed position (see FIG. 1) and an exhaust position (see FIG. 3), and includes an adjusting portion 51, a blocking portion 52 connected to the adjusting portion 51, and a plug portion 53 connected to the blocking portion 52. The adjusting portion 51 is located outside the exhaust valve 40 and can be rotated by the user. The blocking portion 52 is movably disposed in the exhaust passage 42 to make the exhaust hole 43 communicate or not communicate with the exhaust passage 42. An outer diameter of the plug portion 53 is smaller than an inner diameter of the exhaust passage 42 and an outer diameter of the blocking portion 52, and the plug portion 53 is configured to seal or not seal the air inlet 421.

Thus, when the adjusting member 50 is in the closed position (see FIG. 1), the blocking portion 52 blocks the exhaust hole 43 of the exhaust valve 40 from communicating with the exhaust passage 42, and the plug portion 53 seals the air inlet 421 of the exhaust valve 40. When the adjusting member 50 is in the exhaust position (as shown in FIG. 3), the blocking portion 52 allows the exhaust hole 43 of the exhaust valve 40 to communicate with the exhaust passage 42, and the plug portion 53 stops sealing the air inlet 421 of the exhaust valve 40.

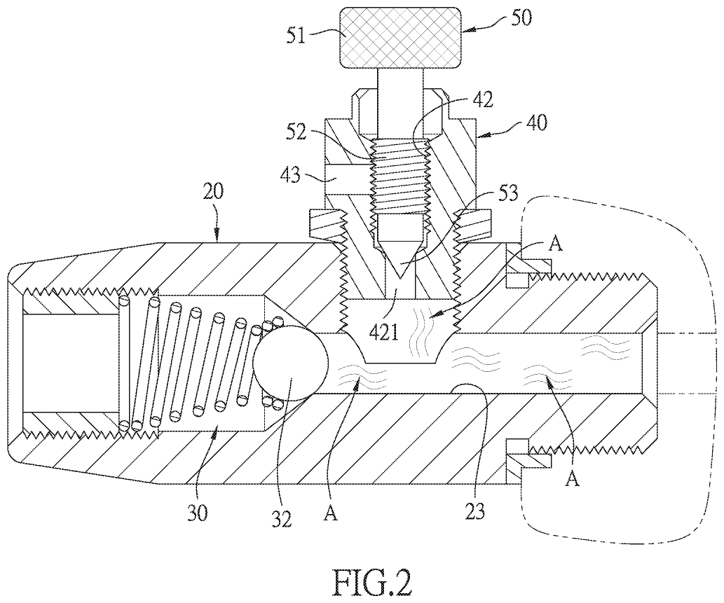

More specifically, as shown in FIG. 4, the exhaust device is screwed to the outlet end 111 of the pneumatic grease gun 11 via the second end 22 of the grease output valve 20. As shown in FIG. 2, when the pneumatic grease gun equipped with the exhaust device has been pressed many times after being filled with grease, the air A in the grease gun will accumulate inside the grease output passage 23 of the grease output valve 20. At this time, since the external air pressure is less than the internal air pressure, the grease is unable to push away the ball 32 of the normally closed unit 30, which results in the failure to discharge grease.

At this time, as shown in FIGS. 2 and 3, the user can rotate the adjusting portion 51 of the adjusting member 50 to adjust the adjusting member 50 to the exhaust position (as shown in FIG. 3), so that the blocking portion 52 of the adjusting member 50 stops blocking the exhaust hole 43 of the exhaust valve 40 from the exhaust passage 42 and lets the exhaust hole 43 communicate with the exhaust passage 42, and at the same time, the plug portion 53 of the adjusting member 50 stops sealing the air inlet 421 of the exhaust valve 40. At this time, the air A in the grease output passage 23 of the grease output valve 20 can flow through the air inlet 421, the exhaust passage 42 and the exhaust hole 43 of the exhaust valve 40 and be exhausted out. After the air A in the grease output valve 20 is evacuated, the adjusting portion 51 of the adjusting member 50 is reversely rotated to return the adjusting member 50 from the exhaust position to the closed position (see FIG. 1). At this time, the external air pressure is greater than the internal air pressure, so that the grease can be pushed towards the outlet direction until the grease pushes away the ball 32 of the normally closed unit 30, and thus the grease can be pumped out.

While we have shown and described various embodiments in accordance with the present invention, it is clear to those skilled in the art that further embodiments may be made without departing from the scope of the present invention.

What is claimed is:

1. An exhaust device for a grease gun comprising:
a grease output valve including a grease output passage and an assembling hole communicating with the grease output passage, the grease output passage including a grease inlet, a grease outlet, and a shrinking hole located between the grease inlet and the grease outlet;
a normally closed unit arranged at the grease outlet of the grease output valve to provide a pre-pressure to seal the shrinking hole;
an exhaust valve assembled to the grease output valve, and including an exhaust passage communicating with the grease output passage, and an exhaust hole communicating with the exhaust passage; and
an adjusting member assembled to the exhaust valve, movable between a closed position and an exhaust position, and including an adjusting portion, a blocking portion movably disposed in the exhaust passage to make the exhaust hole communicate or not communicate with the exhaust passage;
when the adjusting member is in the closed position, the blocking portion blocks the exhaust hole from communicating with the exhaust passage, and when the adjusting member is in the exhaust position, the blocking portion allows the exhaust hole to communicate with the exhaust passage.

2. The exhaust device for the grease gun as claimed in claim 1, wherein the normally closed unit includes a limiting ring, a ball and an elastic element, the limiting ring is disposed at the grease outlet, the ball is configured to seal or not seal the shrinking hole of the grease output valve, and the elastic element is arranged between the limiting ring and the ball to provide a pre-pressure to the ball.

3. The exhaust device for the grease gun as claimed in claim 1, wherein the exhaust passage includes an air inlet communicating with the grease output passage, the adjusting member includes a plug portion connected to the blocking portion, an outer diameter of the plug portion is smaller than an inner diameter of the exhaust passage, the plug portion is configured to seal or not seal the air inlet; and when the adjusting member is in the closed position, the plug portion seals the air inlet, and when the adjusting member is in the exhaust position, the plug portion stops sealing the air inlet.

4. The exhaust device for the grease gun as claimed in claim 3, wherein an outer diameter of the plug portion is smaller than an outer diameter of the blocking portion.

5. The exhaust device for the grease gun as claimed in claim 1, wherein the adjusting portion of the adjusting member is located outside the exhaust valve.
